(19) United States
(12) Patent Application Publication
(10) Pub. No.: US 2008/0082747 A1
(43) Pub. Date: Apr. 3, 2008

(54) APPARATUS AND METHOD FOR PROVIDING DATA PATH REDUNDANCY IN A STORAGE SUBSYSTEM HAVING A SINGLE CONTROLLER

(76) Inventors: Shah Mohammad Rezaul Islam, Tucson, AZ (US); Gregg Steven Lucas, Tucson, AZ (US); Ivan Ronald Olguin, Tucson, AZ (US)

Correspondence Address: Kunzler & McKenzie, 8 EAST BROADWAY, SUITE 600, SALT LAKE CITY, UT, 84111, US

(21) Appl. No.: 11/536,129

(22) Filed: Sep. 28, 2006

(51) Int. Cl. G06F 12/16

(52) U.S. Cl. 711/114

(57) ABSTRACT

The present invention increases the performance of storage subsystems having a single controller while keeping the cost lower than a dual controller storage subsystem. An interface card is positioned in an archetypal second storage controller position. The storage controller and the interface card are connected via a backend communication path which is configured as a data I/O path to facilitate communication between the two. Both the storage controller and the interface card can be connected to the same or different data trafficking devices. An expander chipset can be attached to the interface card to provide a second access port to a redundant array of independent disks. The addition of the interface card provides redundancy to at least one data trafficking device as well as the potential for dual ported access to the RAID. In this respect, the present invention enables dual controller capability at the cost of using only a single controller.

### BACKGROUND OF THE INVENTION

1. Field of the Invention

This invention relates to the implementation of a redundant array of independent disks (RAID) with controllers and more particularly relates to dual controller capability from a single controller design.

2. Description of the Related Art

Dual RAID controller systems provide dual port access to a RAID. Additionally, each controller provides connections to at least one data trafficking device such as a switch. When current systems use only a single RAID controller, neither high bandwidth nor high availability is realizable. Single RAID controller systems are used when cost is the overriding factor. However, bandwidth and availability are compromised in such systems.

Dual controller designs rely on a back-end communication link to connect the controllers. Current single controller designs do not implement the back-end communication link because there are not two controllers for a connection to exist between. Because the back-end communication link is not used in current single controller designs, redundant switch and redundant RAID access are unavailable.

Finally, single controller designs are limited in switch connectivity because they typically have only two interfaces for connecting to a switch. For example, when connectivity to two switches is desired, the controller must use one interface for each switch making redundant connections to the switch unattainable. With dual controller systems each controller can connect to each switch, thus providing switch redundancy that is currently unavailable in single controller designs.

From the foregoing discussion, it should be apparent that a need exists for an apparatus and method for dual controller capability from a single controller design. Beneficially, such an apparatus and method would optimize a cost efficient design for single controller high bandwidth, high availability, and redundant switch connections.

### SUMMARY OF THE INVENTION

The present invention has been developed in response to the present state of the art, and in particular, in response to the problems and needs in the art that have not yet been fully solved by currently available data storage subsystems. Accordingly, the present invention has been developed to provide an apparatus and method for providing data path redundancy in a storage subsystem that overcome many or all of the above-discussed shortcomings in the art.

The apparatus is provided with a plurality of elements configured to collectively provide data path redundancy in a storage subsystem. These elements in the described embodiments include a redundant array of independent disks, a first expander chipset configured as a gateway to the redundant array of independent disks, a storage controller which communicates to the redundant array of independent disks through the first expander chipset, at least one data trafficking device, an interface card capable of connecting to, and configured to communicate with, at least one data trafficking device via at least one data I/O path, the storage controller connected to at least one data trafficking device via at least one data I/O path and to the interface card via a backend communication path configured as a data I/O path.

The apparatus, in one embodiment, is configured to use a feedthrough card as the interface card. In another embodiment, the apparatus is configured to use a repeater card as the interface card. The interface card may be any device capable of communicating received data.

The apparatus is further configured, in one embodiment, to facilitate a second ported access to the redundant array of independent disks. A second expander chipset is attached to the interface card and configured to be a second gateway to the redundant array of independent disks. The interface card is able to communicate to the redundant array of independent disks through the second expander chipset.

A method of the present invention is also presented for providing data path redundancy in a storage subsystem having a single controller. The method in the disclosed embodiments substantially includes the steps necessary to carry out the functions presented above with respect to the operation of the described apparatus. In one embodiment, the method includes providing a storage subsystem. The storage subsystem is comprised of a redundant array of independent disks, a first expander chipset configured to be a first gateway to the redundant array of independent disks, a storage controller connected to the first expander chipset configured to communicate with the redundant array of independent disks through the first expander chipset, and at least one data trafficking device connected to the storage controller by at least one data I/O path.

The method also includes inserting an interface card into a position normally occupied by a second storage controller. The interface card is then connected to at least one data trafficking device by a data I/O path. The interface card is configured to facilitate communication with the data trafficking device. The storage controller and the interface card can be connected to the same or different data trafficking devices.

The method further includes providing a backend communication path configured as a data I/O path identical to the data I/O path extending from the storage controller. The storage controller and the interface card are connected via the backend communication path.

In a further embodiment, the method includes facilitating dual ported access to the redundant array of independent disks by attaching a second expander chipset to the interface card. The second expander chipset is configured as a second gateway to the redundant array of independent disks. The second gateway provides access for the interface card to the redundant array of independent disks through the second expander chipset.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a storage subsystem for providing data path redundancy in a storage subsystem having a single controller in accordance with the present invention;

FIG. 2 is a schematic bock diagram illustrating one embodiment of a storage subsystem providing data path redundancy in a storage subsystem having a single controller in accordance with the present invention; and

FIG. 3 is a schematic flow chart diagram illustrating one embodiment of a method for providing data path redundancy in a storage subsystem having a single controller in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

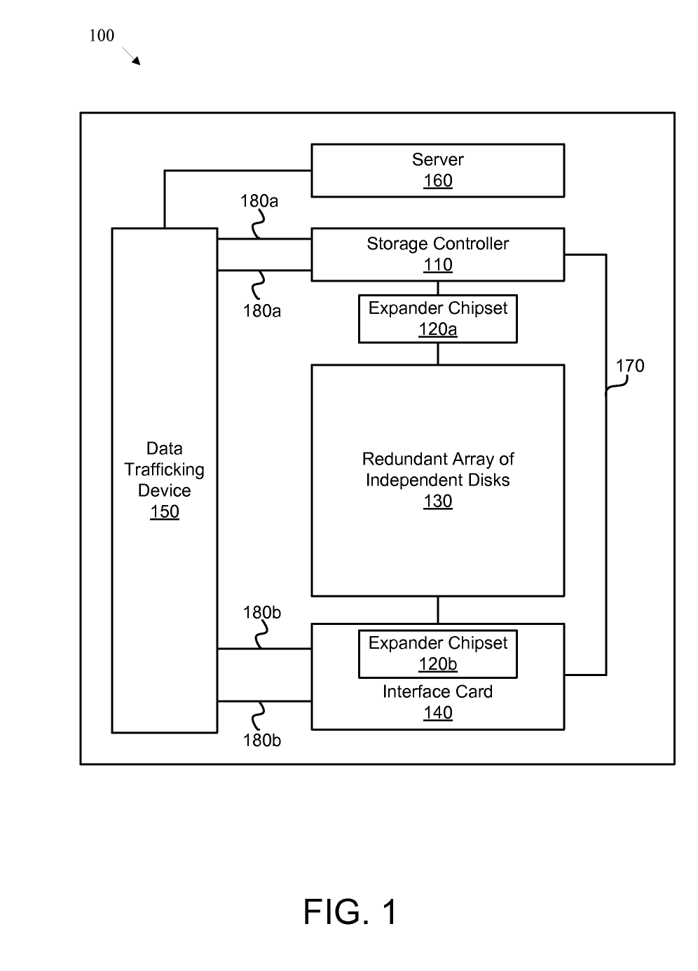

FIG. 1 depicts one embodiment of a storage subsystem for providing data path redundancy in a storage subsystem having a single controller in accordance with the present invention. The depicted storage subsystem 100 includes a storage controller 110, a first and second expander chipset 120, a redundant array of independent disks (RAID) 130, an interface card 140, a data trafficking device 150, a server 160, a backend communication path 170, and data I/O paths 180. The depicted storage subsystem 100 is one embodiment for providing data path redundancy in a storage subsystem having a single controller.

In one embodiment, the storage controller 110 is connected to the first expander chipset 120a. The first expander chipset 120a may connect to the RAID 130. In the depicted embodiment, the first expander chipset 120a presents a gateway for the storage controller 110 to communicate with the RAID 130. The storage controller 110 may manage the physical devices in the RAID 130. The storage controller 110 may use one of a plurality of protocols to communicate with the RAID 130. Such protocols may be IDE, SCSI, SATA, SAS, or fibre channel. In one embodiment, the storage controller 110 interfaces with one of the interface ports of the RAID 130.

In one embodiment, the interface card 140 is inserted in the archetypal second controller position of the storage subsystem. The interface card 140 may be a feedthrough card. In certain embodiments, the interface card 140 is a repeater card. The interface card 140 may be any integrated circuit or expansion card capable of transmitting received data.

The data trafficking device 150 may be any electronic device used to transmit data packets across a network. In the depicted embodiment, the data trafficking device 150 is a network switch. The data trafficking device 150 may be connected to server 160. In certain embodiments, the data trafficking device 150 is connected to a plurality of devices such as workstations, network printers, network switches, storage controllers, and servers.

The storage controller 110 may be connected to the data trafficking device 150 via at least one data I/O path 180a. The interface card 140 may be connected to the data trafficking device 150 via at least one data I/O path 180b. In one embodiment, the data I/O paths 180 are identically configured to pass data packets. The data I/O paths 180 may be configured using one or more protocols. Such protocols may be IDE, SCSI, SATA, SAS, or fibre channel. The data I/O paths may be configured using the same protocol used to access the RAID 130.

In the depicted embodiment, the storage controller 110 and the interface card 140 are connected via the backend communication path 170. The backend communication N X path may be configured identically to the data I/O paths 180. The backend communication path enables another connection between the storage controller 110 and the data trafficking device 150 through the interface card 140.

The second expander chipset 120b may be connected to the interface card 140 to provide a second gateway to the RAID 130. In the depicted embodiment, the expander chipset 120b is physically attached to the interface card 140. In certain embodiments, the expander chipset 120b is connected to the interface card 140 via an interface cable. The interface card 140 may connect to the interface of the RAID 130 not occupied by the storage controller 110. Storage subsystem 100 illustrates redundant connections to the data trafficking device 150 using a single controller design. In the depicted embodiment, storage subsystem 100 illustrates redundant connections to the RAID 130 in a single controller design

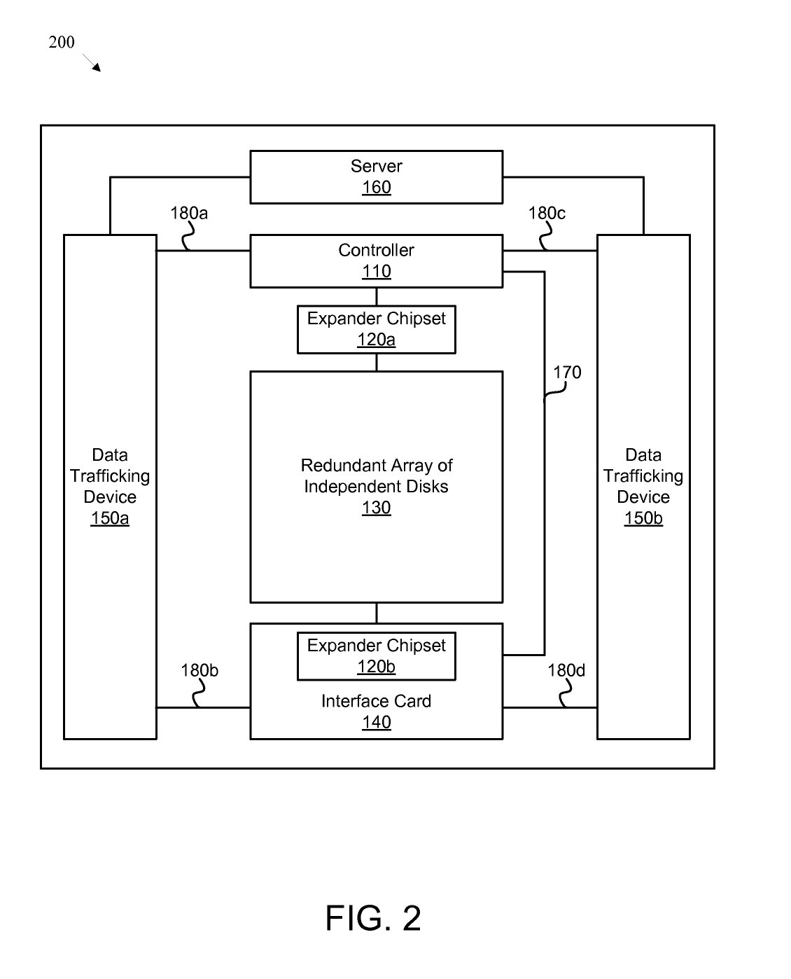

FIG. 2 depicts another embodiment of a storage subsystem for providing data path redundancy in a storage subsystem having a single controller in accordance with the present invention. The depicted apparatus 200 includes a storage controller 110, a first and second expander chipset 120a and 120b, a redundant array of independent disks 130, an interface card 140, data trafficking devices 150, a server 160, a backend communication path 170, and data I/O paths 180. The storage subsystem 200 is one embodiment for dual controller capability from a single controller design.

In the depicted embodiment, the storage controller 110 may be connected to the data trafficking device 150a via data I/O path 180a and connected to the data trafficking device 150b via data I/O path 180c. The interface card 140 may be connected to the data trafficking device 150a via data I/O path 180b and connected to the data trafficking device 150b via data I/O path 180d.

In one embodiment, the data I/O paths 180 are identically configured to pass data packets. The data I/O paths 180 may be configured using one or more protocols. Such protocols may be IDE, SCSI, SATA, SAS, or fibre channel. The data I/O paths may be configured using the same protocol used to access the RAID 130. Storage subsystem 200 illustrates redundant connections to multiple data trafficking devices 150 using a single controller design. In the depicted embodiment, storage subsystem 200 illustrates redundant connections to the RAID 130 in a single controller design.

The schematic flow chart diagrams that follow are generally set forth as logical flow chart diagrams. As such, the depicted order and labeled operators are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

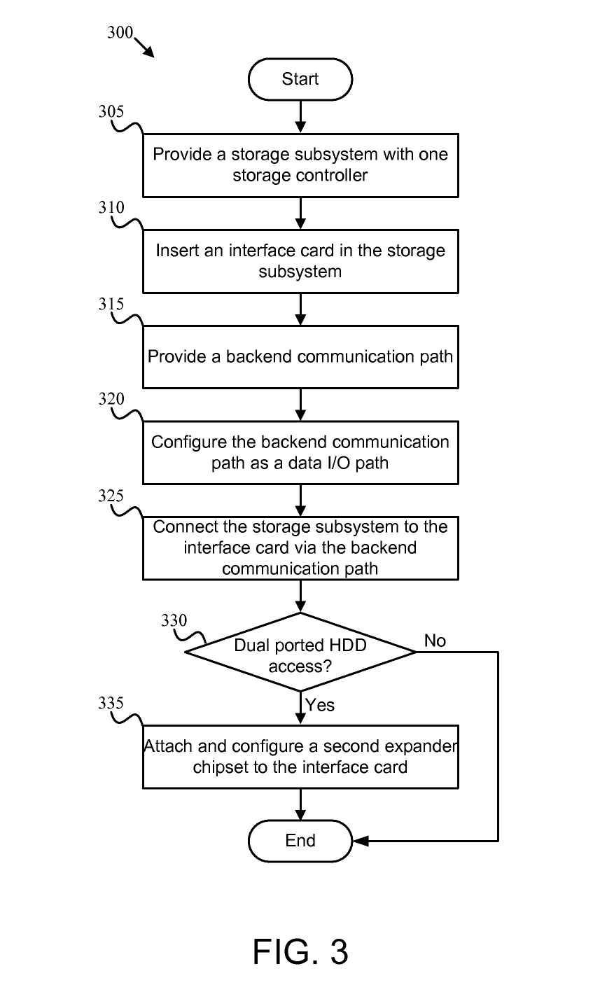

FIG. 3 depicts one sequence for providing data path redundancy in a storage subsystem having a single controller in accordance with the present invention. The sequence 300 includes providing 305 a storage subsystem with one storage controller, inserting 310 an interface card in the storage subsystem, providing 315 a backend communication path, configuring 320 the backend communication path as a data I/O path, connecting 325 the storage subsystem to the interface card via the backend communication path, ascertaining 330 if dual ported hard disk drive access is desired, and attaching 335 and configuring a second expander chipset to the interface card. The sequence 300 teaches providing data path redundancy in a storage subsystem having a single controller.

Providing 305 a storage subsystem with one storage controller includes supplying a redundant array of independent disks, a first expander chipset configured to be a first gateway to the redundant array of independent disks, the storage controller connected to the first expander chipset configured to communicate with the redundant array of independent disks through the first expander chipset, and at least one data trafficking device connected to the storage controller by at least one data I/O path.

Inserting 310 an interface card in the storage subsystem includes locating an unused, archetypal storage controller position within the storage subsystem. The interface card may be inserted in the archetypal storage controller position in the storage subsystem. The archetypal storage controller position may be an expansion socket or other means to facilitate interfacing within the storage subsystem.

Providing 315 a backend communication path facilitates communication between the storage controller and the interface card. Historically, when a storage subsystem comprises two storage controllers, the communication path between them is configured to facilitate communication between storage controllers. Since the communication path facilitates communication between the storage controller and the interface card, the backend communication path may be configured accordingly.

Configuring 320 the backend communication path as a data I/O path includes identifying the protocol and configuration of other data I/O paths within the storage subsystem. In one embodiment, the backend communication path comprises the protocol and configuration of the data I/O paths between the storage controller and one or more data trafficking devices and between the interface card and one or more data trafficking devices. The backend communication path may further comprise the protocol and configuration of the data I/O path used to interface with the RAID.

Connecting 325 the storage subsystem to the interface card via the backend communication path includes interfacing the interface card with the backend communication and interfacing the storage controller with the backend communication. The backend communication configured as a data I/O path facilitates communication between the interface card and the storage controller. The storage controller may be attached to one or more data trafficking devices. The interface card may also be attached to one or more data trafficking devices enabling redundant connections between one or more data trafficking devices.

The method continues by ascertaining 330 if dual ported hard disk drive access is desired. If dual ported hard disk drive access is desired, then attaching 335 and configuring a second expander chipset to the interface card may be necessary. Attaching 335 and configuring a second expander chipset to the interface card may include physically attaching the second expander chipset to the interface card by solder or wire attachment. The second expander chipset provides a second gateway to the RAID extending from the interface card to the RAID. The second gateway may be configured with the same protocol as the first gateway. Attaching 335 and configuring a second expander chipset enables redundant connections to the RAID.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for providing data path redundancy in a storage subsystem having a: single controller, the apparatus comprising:
a redundant array of independent disks;
a first expander chipset configured to be a first gateway to the redundant array of independent disks;
a storage controller connected to the first expander chipset and configured to communicate with the redundant array of independent disks through the first expander chipset;
at least one data trafficking device;
an interface card connected to the at least one data trafficking device via at least one data I/O path and configured to facilitate communication therewith; and
the storage controller further connected to the at least one data trafficking device via at least one data I/O path and to the interface card via a backend communication path configured as a data I/O path.

2. The apparatus of claim 1, wherein the interface card comprises a feedthrough card.

3. The apparatus of claim 1, wherein the interface card comprises a repeater card.

4. The apparatus of claim 1, further comprising a second expander chipset attached to the interface card, the second expander chipset configured to be a second gateway to the redundant array of independent disks.

5. A method for providing data path redundancy in a storage subsystem having a single controller, the method comprising:
providing a storage subsystem comprising a redundant array of independent disks, a first expander chipset configured to be a first gateway to the redundant array of independent disks, a storage controller connected to the first expander chipset and configured to communicate with the redundant array of independent disks through the first expander chipset, and at least one data trafficking device connected to the storage controller by at least one data I/O path;
inserting an interface card in an unused storage controller position of the storage subsystem, connecting the interface card to at least one data trafficking device via at least one data I/O path, and configuring the interface card to facilitate communication with the data trafficking device;
providing a backend communication path configured as a data I/O path identical to the at least one data I/O path; and
connecting the storage controller to the interface card via the backend communication path.

6. The method of claim 5, further comprising attaching a second expander chipset to the interface card, the second expander chipset configured to be a second gateway to the redundant array of independent disks.
